(19) United States
(12) Patent Application Publication
(10) Pub. No.: US 2026/0346674 A1
(43) Pub. Date: Nov. 5, 2026

(54) ROOF-MOUNTED AIR CONDITIONER AND VEHICLE

(71) Applicant: GD MIDEA AIR-CONDITIONING EQUIPMENT CO., LTD., Foshan (CN)

(72) Inventor: Yinyin ZHANG, Foshan (CN)

(21) Appl. No.: 19/124,601

(22) PCT Filed: Nov. 30, 2022
(86) PCT No.: PCT/CN2022/135541

§ 371 Date: Apr. 25, 2025

(30) Foreign Application Priority Data
Nov. 18, 2022 (CN) 202211445655.0
Nov. 18, 2022 (CN) 202211445676.2
Nov. 18, 2022 (CN) 202223091525.X

(51) Int. Cl. B60H 1/00

(52) U.S. Cl. CPC B60H 1/00207; B60H 1/00535; B60H 2001/00235

(57) ABSTRACT

A roof-mounted air conditioner includes an air conditioner body, a sealing ring configured to be fixed to an outer side of a roof of a vehicle, a support plate mounted at a bottom of the air conditioner body, provided with a first communication hole, having one end facing downward abutting against the sealing ring, and with an outer skirt arranged along an outer periphery of the support plate and in positioning fit with an outer wall of the sealing ring, and a top plate located below the support plate, fixedly connected to the air conditioner body by bolts, and being provided with a second communication hole. When the air conditioner is mounted to an mounting opening on the roof, the sealing ring is arranged around a periphery of the mounting opening, and the second communication hole is in communication with the first communication hole through the mounting opening.

### CROSS-REFERENCE TO RELATED APPLICATIONS

This application claims priority to Chinese Patent Application No. 202211445655.0, filed on Nov. 18, 2022 and entitled “ROOF-MOUNTED AIR CONDITIONER AND VEHICLE,” Chinese Patent Application No. 202223091525.X, filed on Nov. 18, 2022 and entitled “ROOF-MOUNTED AIR CONDITIONER AND VEHICLE,” and Chinese Patent Application No. 202211445676.2, filed on Nov. 18, 2022 and entitled “ROOF-MOUNTED AIR CONDITIONER AND VEHICLE,” the entire contents of all of which are incorporated herein by reference.

### FIELD

The present disclosure relates to the technical field of air conditioning equipment, and in particular, to a roof-mounted air conditioner and a vehicle.

### BACKGROUND

In the related art, a recreational vehicle air conditioner is usually mounted at the roof of the recreational vehicle, to adjust a temperature of interior environment of the recreational vehicle. A conventional recreational vehicle air conditioner requires operator to move back and forth between the roof and the interior of the vehicle many times to ensure that the installation is properly aligned resulting in low mounting efficiency and accuracy.

### SUMMARY

The present disclosure aims to resolve at least one of problems existing in the existing technology. To this end, the present disclosure provides a roof-mounted air conditioner, which may be accurately positioned in a mounting opening of a vehicle roof in a quick installation way, thereby improving mounting efficiency and accuracy.

The present disclosure further provides a vehicle having the roof-mounted air conditioner.

In accordance with a first aspect of the present disclosure, an embodiment provides a roof-mounted air conditioner, which is configured to be mounted to a mounting opening on a roof of a vehicle and includes: an air conditioner body; a sealing ring, fixed to an outer side of the roof; a support plate, mounted at a bottom of the air conditioner body, and the support plate is provided with a first communication hole, one end of the support plate facing downward abuts against the sealing ring, and along an outer periphery of the support plate is provided with an outer skirt, the outer skirt is positioned and fitted with an outer wall of the sealing ring; and a top plate, located below the support plate and fixedly connected to the air conditioner body by bolts, and the top plate is provided with a second communication hole; when the air conditioner is mounted to the roof, the sealing ring is arranged around a periphery of the mounting opening, and the second communication hole is in communication with the first communication hole through the mounting opening.

The roof-mounted air conditioner according to the embodiment of the first aspect of the present disclosure has at least the following advantages.

By providing a support plate mounted at the bottom of the air conditioner body, a sealing ring fixed to the outer side of the roof, and a top plate mounted to an inner side of the roof and connected to the air conditioner body by bolts, the sealing ring is arranged around the periphery of the mounting opening on the roof, and the end of the support plate facing downward is provided with the outer skirt that is configured to be positioned and fitted with the outer wall of the sealing ring. Therefore, after an operator aligns the sealing ring with the mounting opening, the air conditioner body may be quickly and accurately aligned with the mounting opening through a positioning relationship between the outer skirt and the sealing ring, such that the operator does not need to move back and forth between the roof and an interior of the vehicle many times for adjustment, thereby improving mounting efficiency and accuracy.

In accordance with a second aspect of the present disclosure, an embodiment provides a roof-mounted air conditioner, which is configured to be mounted to a mounting opening on a roof of a vehicle and includes: an air conditioner body; a support plate mounted at a bottom of the air conditioner body, and the support plate is provided with a first communication hole, one end of the support plate facing downward is provided with an inner skirt; and a top plate, located below the support plate and fixedly connected to the air conditioner body by bolts, and the top plate is provided with a second communication hole; when the roof-mounted air conditioner is mounted to the roof, the inner skirt is in positioning fit with an inner wall of the mounting opening, and the second communication hole is in communication with the first communication hole through the mounting opening.

The roof-mounted air conditioner according to the embodiment of the second aspect of the present disclosure has at least the following advantages.

By providing a support plate mounted at the bottom of the air conditioner body, and a top plate mounted to an inner side of the roof and connected to the air conditioner body by bolts, the end of the support plate facing downward is provided with the inner skirt, and the inner skirt is configured to be in positioning fit with the inner wall of the mounting opening on the roof. Therefore, operator may quickly and accurately align the air conditioner body with the mounting opening, such that the operator does not need to move back and forth between the roof and an interior of the vehicle many times for adjustment, thereby improving mounting efficiency and accuracy. In addition, the air conditioner body may be effectively prevented from shaking or shifting when the operator installs the top plate, thereby improving mounting safety.

In accordance with a third aspect of the present disclosure, an embodiment provides a vehicle, which includes the roof-mounted air conditioner in the embodiment of the first aspect or the embodiment of the second aspect.

Additional aspects and advantages of the present disclosure will be partly given in and partly apparent from the description below, or may be learned by the practice of the disclosure.

### BRIEF DESCRIPTION OF DRAWINGS

The present disclosure will be further described below in conjunction with accompanying drawings and embodiments. In the drawings:

FIG. 1 is a schematic diagram of a roof-mounted air conditioner mounted to a roof of a vehicle according to an embodiment of the present disclosure;

FIG. 2 is an exploded view of the roof-mounted air conditioner shown in FIG. 1;

FIG. 3 is a bottom view of an air conditioner body and a support plate in FIG. 2 after being assembled;

FIG. 4 is a top view of the roof-mounted air conditioner shown in FIG. 1;

FIG. 5 is a sectional view of the roof-mounted air conditioner taken along line A-A in FIG. 4;

FIG. 6 is a sectional view of the roof-mounted air conditioner taken along line B-B in FIG. 4;

FIG. 7 is an enlarged structural view of the support plate in FIG. 2;

FIG. 8 is an enlarged structural view of the top plate in FIG. 2;

FIG. 9 is a front view of the top plate shown in FIG. 8;

FIG. 10 is a schematic sectional view of a roof-mounted air conditioner according to another embodiment of the present disclosure, with the bolts in an unfastened state;

FIG. 11 is a schematic sectional view of a roof-mounted air conditioner according to another embodiment of the present disclosure, with the bolts in a fastened state;

FIG. 12 is an exploded view of the roof-mounted air conditioner shown in FIG. 1;

FIG. 13 is a bottom perspective view of the air conditioner body, the support plate, and a sealing ring in FIG. 12 after being assembled;

FIG. 14 is a top view of the roof-mounted air conditioner shown in FIG. 1;

FIG. 15 is a sectional view of the roof-mounted air conditioner taken along line A-A in FIG. 14, with the bolts in an unfastened state;

FIG. 16 is an enlarged view of part B in FIG. 15;

FIG. 17 is a sectional view of the roof-mounted air conditioner taken along line A-A in FIG. 14, with the bolts in a fastened state;

FIG. 18 is an enlarged view of part C in FIG. 17;

FIG. 19 is an enlarged structural view of the support plate in FIG. 12;

FIG. 20 is an enlarged structural view of the top plate of FIG. 12;

FIG. 21 is a schematic sectional view of a roof-mounted air conditioner according to another embodiment of the present disclosure;

FIG. 22 is an enlarged view of part E in FIG. 21;

FIG. 23 is an enlarged structural view of the support plate in FIG. 21; and

FIG. 24 is an enlarged structural view of the top plate in FIG. 21.

Reference numerals as followings:
air conditioner body 100; chassis 110; positioning rib 111; metal nut 112; top cover 120; internal air duct assembly 130; indoor heat exchanger 131; external air duct assembly 140; outdoor heat exchanger 141;
support plate 200; first communication hole 210; outer skirt 220; inner skirt 230; indication protrusion 240;
top plate 300; second communication hole 310; partition plate 320; positioning boss 330; end plate 331; side plate 332; fixation hole 333; mounting flange 340; attachment member 350; hole 360;
sealing ring 400;
bolt 500;
damping pad 600;
roof 2000; and mounting opening 2100.

### DETAILED DESCRIPTION OF EMBODIMENTS

Embodiments of the present disclosure will be described in detail hereinafter in conjunction with accompanying drawings in which the same or like reference numerals refer to the same or like elements or elements having the same or like functions throughout. The embodiments described below by reference to the accompanying drawings are exemplary and are intended for illustration only and are not to be construed as limiting the present disclosure.

In the description of the present disclosure, it should be understood that orientation or position relationships indicated by the terms such as up, down and the like are based on orientation or position relationships shown in the accompanying drawings, and are used only for ease and brevity of illustration and description, rather than indicating or implying that the mentioned apparatus or component need to have a particular orientation or need to be constructed and operated in a particular orientation. Therefore, such terms should not be construed as limiting of the present disclosure.

In the description of the present disclosure, “a plurality of/multiple” means two or more than two. The terms such as first, second and the like used herein are merely used for distinguishing technical features, and are not intended to indicate or imply relative importance, or implicitly point out the number of the indicated technical features, or implicitly point out the order of the indicated technical features.

In the description of the present disclosure, unless otherwise explicitly defined, the terms such as “configure,” “install/mount” and “connect” should be understood in a broad sense, and those having ordinary skills in the art can reasonably determine the specific meanings of the above terms in the present disclosure based on the specific contents of the technical scheme.

With the development of economy, people's pursuit for travel and tourism quality of life is increasing, and a recreational vehicle has gradually become a living place for people during travel. Therefore, higher requirements are put forward on environment of the recreational vehicle, and a recreational vehicle air conditioner emerges. The recreational vehicle air conditioner, as the main electrical equipment to improve the indoor environment of the vehicle, has gradually become an essential device for a modern recreational vehicle.

The recreational vehicle air conditioner is usually mounted to a roof 2000 of a vehicle, so that the recreational vehicle air conditioner is also referred to as a roof-mounted air conditioner. The roof-mounted air conditioner communicates with a mounting opening 2100 on the roof 2000 from below, providing an air conditioning function for the interior environment of the recreational vehicle. Since being mounted to the recreational vehicle, the roof-mounted air conditioner is subject to continuous vibration of the recreational vehicle during travel, such that assembly reliability of the roof-mounted air conditioner is particularly important. However, alignment of a conventional roof-mounted air conditioner is difficult during mounting to the recreational vehicle, and requires operator to move back and forth between the roof 2000 and the interior of the vehicle many times to make sure the installation is aligned properly, and mounting accuracy of the roof-mounted air conditioner is difficult to control. Consequently, connection reliability of the roof-mounted air conditioner is affected, resulting in low mounting efficiency and accuracy of the roof-mounted air conditioner.

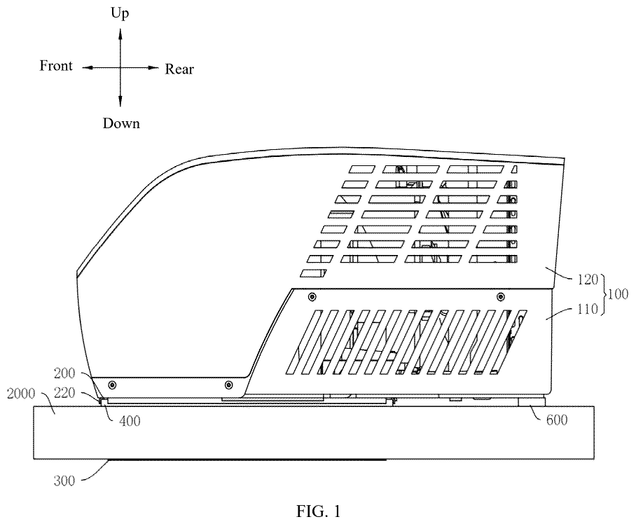

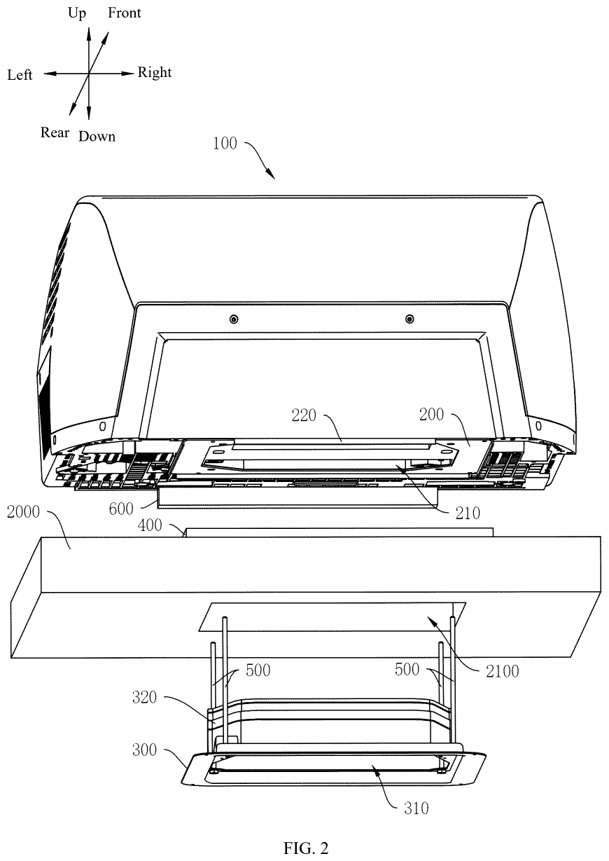

It should be noted that the orientations in the embodiments of the present disclosure, such as front, rear, up, and down are all described with respect to an air conditioner body 100, and with reference to orientation relationships indicated in FIG. 1 and FIG. 2. The front, rear, up, and down directions of the roof-mounted air conditioner correspond to those of the recreational vehicle.

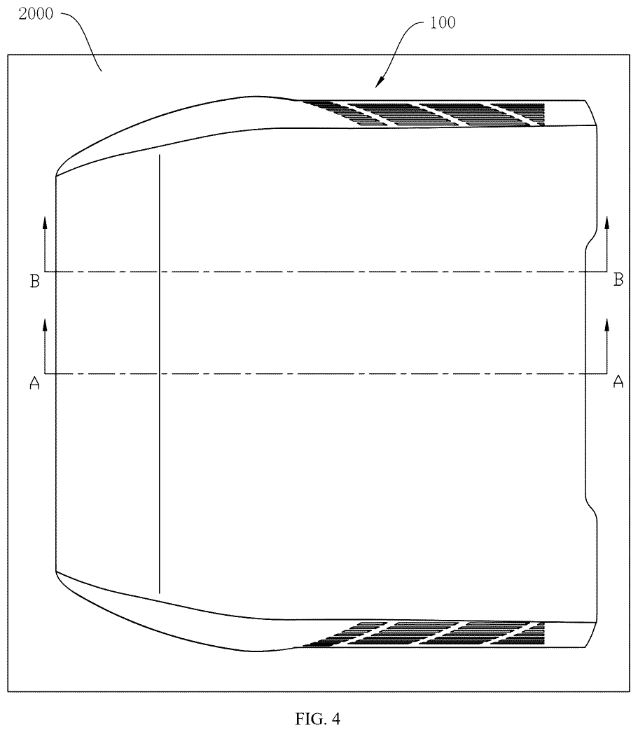

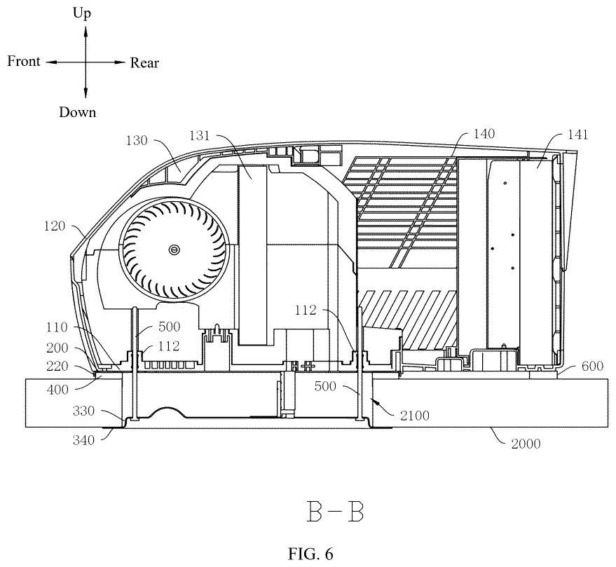

With reference to FIG. 1 and FIG. 2, to resolve the mounting problem of the roof-mounted air conditioner, a roof-mounted air conditioner according to an embodiment of the present disclosure includes an air conditioner body 100, a support plate 200, a top plate 300, and a sealing ring 400. The air conditioner body 100 includes a chassis 110, a top cover 120, an internal air duct assembly 130 having an indoor heat exchanger 131, an external air duct assembly 140 having an outdoor heat exchanger 141, a compressor, and an electric control box assembly. The chassis 110 is a main load-bearing member of the air conditioner body 100, and the internal air duct assembly 130, the external air duct assembly 140, the compressor, and the electric control box assembly are directly or indirectly mounted to the chassis 110. The support plate 200 and the top plate 300 are respectively arranged on an outer side and an inner side of a roof 2000 of a recreational vehicle, the top plate 300 is located below the support plate 200, the support plate 200 is fixedly connected to a bottom of the chassis 110, and the support plate 200 may be mounted to the chassis 110 by screws or the like. Referring to FIG. 4 and FIG. 6, the top plate 300 may be fixedly connected to the chassis 110 by bolts 500, and a metal nut 112 may be embedded into the chassis 110 through injection molding to be threadedly engaged with the bolt 500, thereby the air conditioner body 100 and the top plate 300 may be clamped against the roof 2000, establishing a stable and reliable connection between the roof-mounted air conditioner and the recreational vehicle.

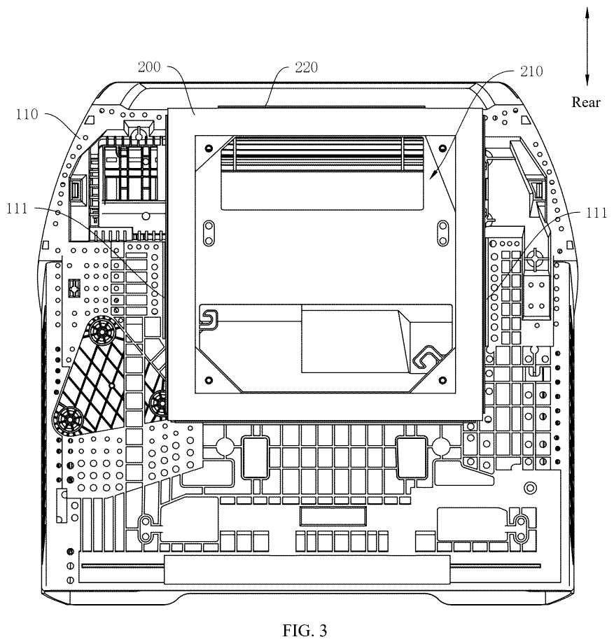

Referring to FIG. 3, it may be understood that the chassis 110 is provided with a positioning rib 111 arranged at the bottom of the chassis 110 and protruding outward. A plurality of positioning ribs 111 may be provided, and are positioned and engaged with a periphery of the support plate 200, to facilitate determining of a mounting position of the support plate 200 and establish a stable connection between the support plate 200 and the chassis 110.

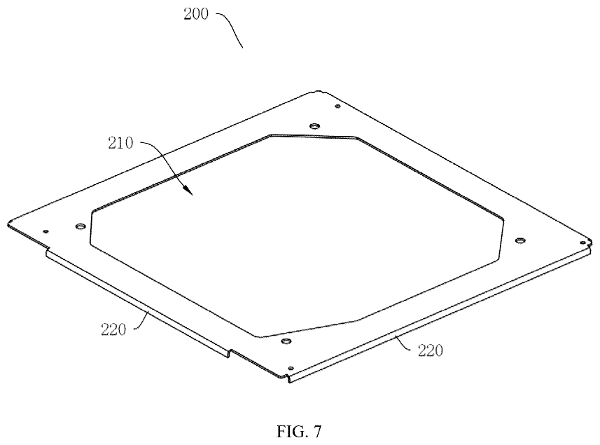

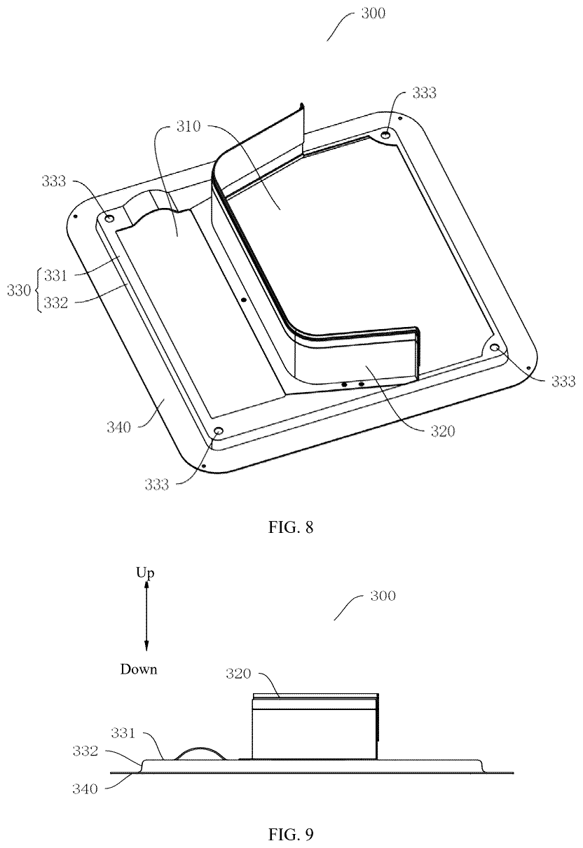

Referring to FIG. 2, FIG. 7, and FIG. 8, it may be understood that, to enable an air inlet and an air outlet of the air conditioner body 100 to be in communication with internal environment of the recreational vehicle, the support plate 200 is provided with a first communication hole 210, and the top plate 300 is provided with a second communication hole 310. When the roof-mounted air conditioner is mounted to the roof 2000, the second communication hole 310 is in communication with the first communication hole 210 through a mounting opening 2100. To avoid airflow communication between the air inlet and the air outlet of the air conditioner body 100, the top plate 300 is provided with a partition plate 320 configured to divide the mounting opening 2100 into an air inlet passage and an air outlet passage.

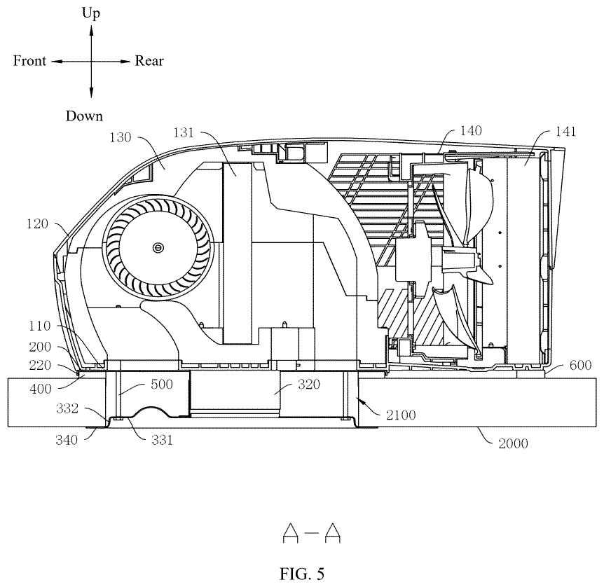

Referring to FIG. 1 and FIG. 2, it may be understood that, when the roof-mounted air conditioner is mounted to the roof 2000, the sealing ring 400 may be fixed surrounding a periphery of the mounting opening 2100 on the outer side of the roof 2000 using adhesive or the like, thereby realizing alignment installation with the mounting opening 2100. Referring to FIG. 4, FIG. 5, and FIG. 7, one end of the support plate 200 facing the mounting opening 2100 abuts against the sealing ring 400. The support plate 200 is further provided with an outer skirt 220 located at one end of the support plate 200 facing downward, that is, the end facing the mounting opening 2100, and the outer skirt 220 is arranged along an outer periphery of the support plate 200. The outer skirt 220 may be integrally molded with the support plate 200, that is, formed by folding downward the outer periphery of the support plate 200. In another embodiment, the outer skirt 220 is fixedly connected to the support plate 200 through welding or the like. In addition, arrangement of the outer skirt 220 may also enhance structural strength of the support plate 200, thereby improving mounting stability of the roof-mounted air conditioner.

It may be understood that the support plate 200 may be in positioning fit with an outer wall of the sealing ring 400 through the outer skirt 220. Therefore, after operator mounts the sealing ring 400 in alignment with the mounting opening 2100, the air conditioner body 100 may be quickly and accurately aligned with the mounting opening 2100 through a positioning relationship between the outer skirt 220 and the sealing ring 400, such that the operator does not need to move back and forth between the roof 2000 and the interior of the vehicle many times for adjustment, thereby improving mounting efficiency and accuracy, and improving safety of the operator. Moreover, the positioning fit between the outer skirt 220 and the sealing ring 400 may effectively prevent the air conditioner body 100 from shaking or shifting when the operator is mounting the top plate 300, making it more efficient and convenient for the operator to fasten the bolts 500, and the air conditioner body 100 may be prevented from slipping and damaged, thereby improving mounting safety.

Referring to FIG. 2 and FIG. 5, it may be understood that the top plate 300 and the chassis 110 may be fixed by a plurality of bolts 500. The number of bolts 500 may be selected based on a size of the air conditioner body 100 and a size of the mounting opening 2100, which may be, for example, four, six or more, and is not specifically limited herein. The plurality of bolts 500 are arranged close to an inner wall of the mounting opening 2100, and are arranged at an interval along a circumferential direction of the mounting opening 2100, thereby reducing an impact of the bolts 500 on the air inlet and the air outlet of the roof-mounted air conditioner.

Further, as compared to a mounting arrangement of the conventional roof-mounted air conditioner, the roof-mounted air conditioner in this embodiment of the present disclosure involves fewer parts and operation step for installations, which is conducive to improving mounting efficiency.

Referring to FIG. 5, it may be understood that the sealing ring 400 is arranged between the support plate 200 and the roof 2000 to provide effective sealing, such that the air inlet and the air outlet of the air conditioner body 100 are in sealed communication with the internal environment of the recreational vehicle through the mounting opening 2100. The sealing ring 400 in this embodiment of the present disclosure is made of an elastic material having compressibility, such as sponge, expandable polyethylene, and EVA (also referred to as ethylene-vinyl acetate copolymer). Therefore, the sealing ring 400 may further provide better cushioning effect on vibrations between the air conditioner body 100 and the roof 2000, effectively reduce transmission of vibration generated during bumpy travel of the recreational vehicle to the air conditioner body 100, and reduce shaking of the air conditioner body 100, thereby improving stability of the roof-mounted air conditioner mounted to the recreational vehicle.

Referring to FIG. 1 and FIG. 3, it may be understood that the roof-mounted air conditioner includes a damping pad 600 that may provide a further cushioning effect. When the roof-mounted air conditioner is mounted to the roof 2000, the damping pad 600 is arranged between the air conditioner body 100 and the roof 2000, and the damping pad 600 is spaced apart from the sealing ring 400 in a front-rear direction of the air conditioner body 100. It may be understood that the damping pad 600 is arranged at a rear portion of the chassis 110 and the sealing ring 400 is arranged at a front portion of the chassis 110, such that the air conditioner body 100 receive more evenly distributed forces, transmission of vibration generated during bumpy travel of the recreational vehicle to the air conditioner body 100 is further reduced, and shaking of the air conditioner body 100 is reduced, thereby improving stability of the roof-mounted air conditioner mounted to the recreational vehicle.

Referring to FIG. 8 and FIG. 9, it may be understood that the top plate 300 includes a positioning boss 330 and a mounting flange 340. The mounting flange 340 is arranged around a periphery of the positioning boss 330. The top plate 300 may be produced by integral stamping, to enhance strength of the positioning boss 330 and the mounting flange 340. Referring to FIG. 5, the positioning boss 330 protrudes toward the mounting opening 2100 and is configured to be in positioning fit with the inner wall of the mounting opening 2100. It may be understood that the positioning boss 330 includes an end plate 331 located at one end of the positioning boss 330 facing the support plate 200 and a side plate 332 arranged around the end plate 331 and connected to the mounting flange 340. The side plate 332 is configured to abut against the inner wall of the mounting opening 2100 to limit displacement of the top plate 300 in a horizontal direction of the roof 2000, while the mounting flange 340 is configured to abut against the inner side of the roof 2000 to limit displacement of the top plate 300 in a thickness direction of the roof 2000, thereby realizing accurate alignment of the top plate 300. This embodiment of the present disclosure may effectively prevent the top plate 300 from shaking within the mounting opening 2100, and prevent the air conditioner body 100 from shaking accordingly, thereby improving mounting accuracy of the top plate 300, and facilitating the operator to fasten the bolts 500 between the top plate 300 and the chassis 110.

Referring to FIG. 8, it may be understood that the end of the positioning boss 330 facing the support plate 200 is provided with the end plate 331, the second communication hole 310 is formed in the end plate 331. The end plate 331 is provided with a fixation hole 333 for the bolt 500 to be inserted into and fixed to the end plate 331. It may be understood that the fixation holes 333 are distributed around the second communication hole 310, so as to prevent the bolts 500 from affecting the air inlet passage and the air outlet passage after being secured in the fixation hole 333.

In this embodiment of the present disclosure, a cross section of the mounting opening 2100 is rectangular, and the positioning boss 330 matches with the mounting opening 2100 in shape and is also rectangular. It should be noted that four fixation holes 333 are provided and are respectively located at four corners of the end plate 331, that is, on a side close to the inner wall of the mounting opening 2100. Correspondingly, four bolts 500 are provided, which are respectively secured in the four fixation holes 333 and are fixedly connected to the chassis 110, thereby realizing a stable connection between the top plate 300 and the chassis 110, and further realizing a stable connection between the roof-mounted air conditioner and the roof 2000. It should be noted that the mounting flange 340 is flush against a lower end of the mounting opening 2100. Because the positioning boss 330 and the mounting flange 340 are integrally stamped, the mounting flange 340 transmits a fastening force against the positioning boss 330 when the bolt 500 is fastened upward, such that the mounting flange 340 may be upward secured to the roof 2000 and fastening forces of the four bolts 500 may be evenly distributed. The mounting flange 340 is in a surface contact with the roof 2000 when they clamp, thereby realizing a more stable and reliable installation.

Referring to FIG. 7, it may be understood that the outer skirt 220 is formed by folding downward the outer periphery of the support plate 200, to enhance strength of the outer skirt 220, and the outer skirt 220 may also enhance structural strength of the support plate 200, thereby improving mounting stability of the roof-mounted air conditioner.

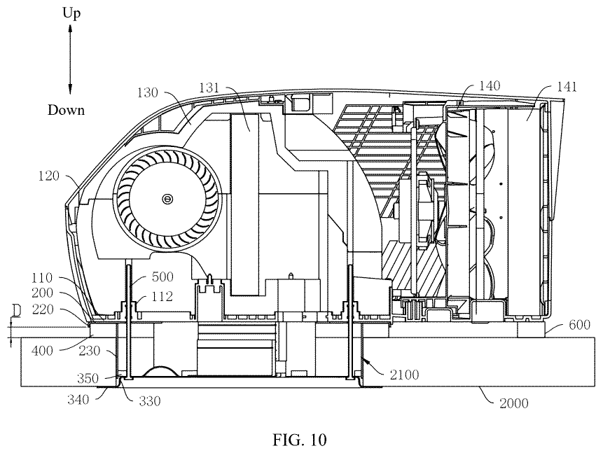

FIG. 10 shows a roof-mounted air conditioner according to another embodiment of the present disclosure. To facilitate mounting of the top plate 300 by the operator, the top plate 300 is designed to be prefixed to the support plate 200 by, for example a movable fastener, a clamp, or a magnet, in this embodiment of the present disclosure. Therefore, after an air conditioner body 100 is positioned through the support plate 200, the operator in a recreational vehicle may finish the work of pre-fixing the top plate 300 to the support plate 200. To be specific, the top plate 300 may be secured by directly fastening bolts 500 with two hands. There is no need for a person to hold the top plate 300 with one hand while fasten the bolt 500 with the other hand, nor is there a need for one person to hold the top plate 300 while another person is fastening the bolt 500, thereby improving mounting efficiency and reducing mounting costs.

Referring to FIG. 10, in an embodiment, the support plate 200 is provided with an inner skirt 230 located at one end of the support plate 200 facing downward, that is, the end facing the mounting opening 2100. A mechanism for realizing the prefixation may be an attachment member 350, and the attachment member 350 may be arranged on the top plate 300, the inner skirt 230, or both the top plate 300 and the inner skirt 230. The top plate 300 and the inner skirt 230 are attached and connected by the attachment member 350 to realize the pre-fixation. In an embodiment, the attachment member 350 may be a magnet, an adhesive, or any other material that can realize attachment of the top plate 300 and the inner skirt 230.

Referring to FIG. 10, it may be understood that, in order to facilitate production and manufacturing, the attachment member 350 in this embodiment of the present disclosure is a magnet. The attachment member 350 is arranged on the top plate 300, the inner skirt 230 is made of a metal material, and the attachment member 350 is easily attached to the inner skirt 230, thereby realizing the pre-fixation of the top plate 300. This requires lower production costs, and has a more stable structure. A plurality of attachment members 350 may be provided. The plurality of attachment members 350 are arranged at an interval along a circumferential direction of the top plate 300 and are each fixed to the top plate 300, such that the pre-fixation of the top plate 300 is more stable, and a risk of falling off of the top plate 300 is effectively prevented.

It may be understood that, in another embodiment, the top plate 300 is provided with a first fastener, and the support plate 200 is provided with a second fastener. It may be understood that the first fastener may be one of a movable buckle and a ring that match with each other, and correspondingly, the second fastener is the other one of the movable buckle and the ring. After the movable buckle is connected to the ring, the top plate 300 and the support plate 200 can be prefixed, such that the operator may fasten the top plate 300 by directly fastening the bolt 500 with two hands, thereby improving mounting efficiency.

It may be understood that, in another embodiment, the top plate 300 is provided with a first adhesive member configured to be adhered to the roof 2000. It may be understood that the first adhesive member is arranged at a proper position of the top plate 300, and when the operator mounts the top plate 300, the top plate 300 may be prefixed to an inner side of the roof 2000 or an inner wall of the mounting opening 2100 through the first adhesive member, such that the top plate 300 is prefixed to the support plate 200, and the operator may fasten the top plate 300 by directly fastening the bolt 500 with two hands, thereby improving mounting efficiency.

It should be understood that, in another embodiment, the top plate 300 or the inner skirt 230 is provided with a second adhesive member, or both the top plate 300 and the inner skirt 230 are provided with a second adhesive member. The second adhesive member is configured to adhere to the top plate 300 and the inner skirt 230 when the roof-mounted air conditioner is mounted to the roof 2000. It may be understood that the second adhesive member may be made of a material such as double-sided tape, and the second adhesive member is arranged at a proper position of the top plate 300 and/or the inner skirt. When the operator mounts the top plate 300, the top plate 300 may be adhered to the inner skirt 230 through the second adhesive member to realize pre-fixation, such that the operator may fasten the top plate 300 by directly fastening the bolt 500 with two hands, thereby improving mounting efficiency.

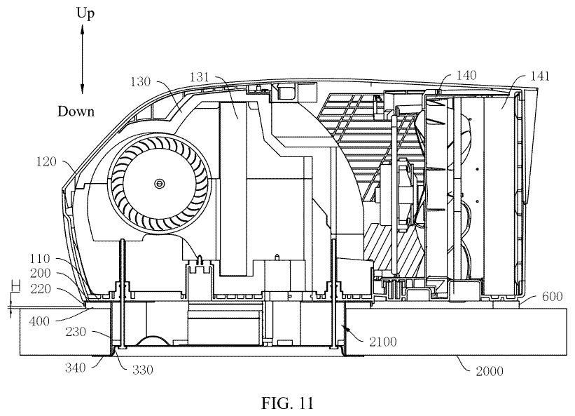

Referring to FIG. 10, it may be understood that, when the bolt 500 is in an unfastened state, that is, when the bolt 500 is not fastened to the top plate 300, a clearance between the outer skirt 220 and an upper end face of the mounting opening 2100 is defined as D. Referring to FIG. 11, it may be understood that, when the bolt 500 is in a fastened state, that is, after the roof-mounted air conditioner is mounted to the roof 2000, a clearance between the outer skirt 220 and the upper end face of the mounting opening 2100 is defined as H, which satisfies: 0<H≤0.5 D. It should be noted that, when 0<H≤0.5 D is satisfied, the sealing ring 400 may be compressed to a certain extent after the bolt 500 is fastened, to form a sealed fit with the roof 2000, and the cushioning and damping effects of the sealing ring 400 are ensured at the same time.

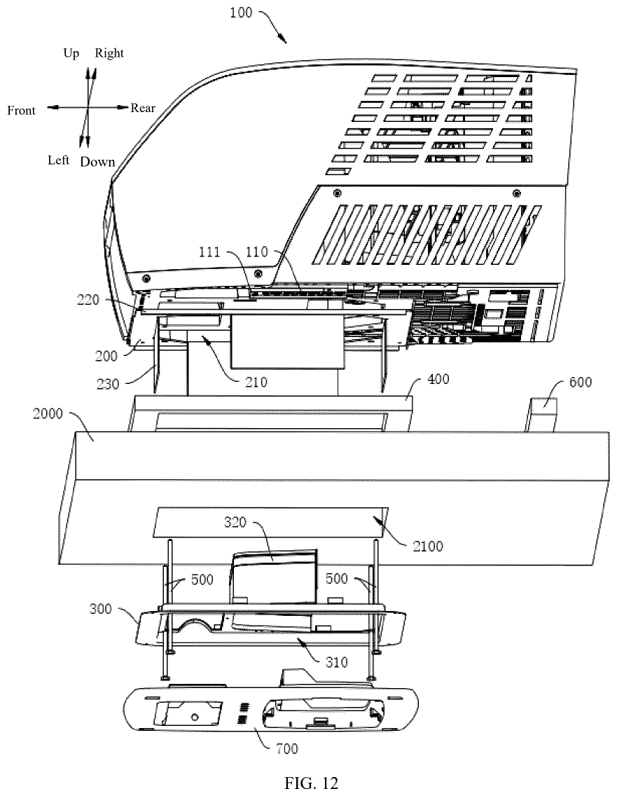

Referring to FIG. 1 and FIG. 12, to resolve a mounting problem of the roof-mounted air conditioner, a roof-mounted air conditioner according to another embodiment of the present disclosure includes an air conditioner body 100, a support plate 200, and a top plate 300. The air conditioner body 100 includes a chassis 110, a top cover 120, an internal air duct assembly 130 having an indoor heat exchanger 131, an external air duct assembly 140 having an outdoor heat exchanger 141, a compressor, and an electric control box assembly. The chassis 110 is a main load-bearing member of the air conditioner body 100, and the internal air duct assembly 130, the external air duct assembly 140, the compressor, and the electric control box assembly are directly or indirectly mounted to the chassis 110. The support plate 200 and the top plate 300 are respectively arranged on an outer side and an inner side of a roof 2000 of a recreational vehicle. The top plate 300 is located below the support plate 200, the support plate 200 is fixedly connected to a bottom of the chassis 110, and the support plate 200 may be mounted to the chassis 110 by a screw. The top plate 300 may be fixedly connected to the chassis 110 by bolts 500, and a metal nut 112 may be embedded into the chassis 110 through injection molding to be threadedly engaged with the bolt 500, thereby the air conditioner body 100 and the top plate 300 may be clamped against the roof 2000, establishing a stable and reliable connection between the roof-mounted air conditioner and the recreational vehicle.

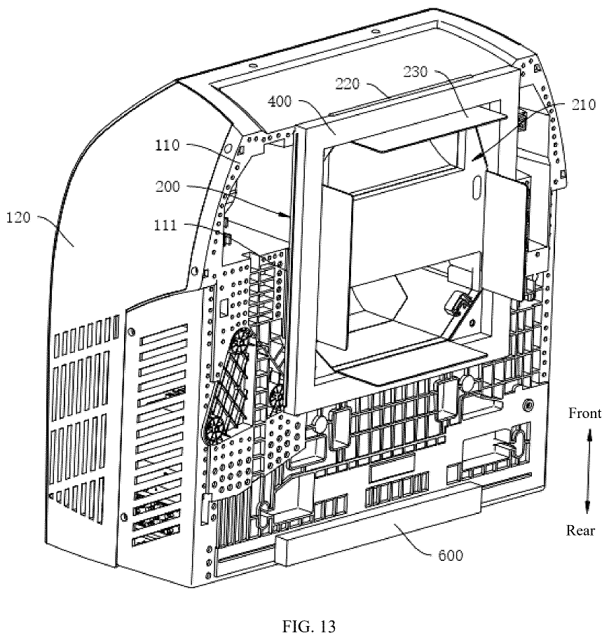

Referring to FIG. 12 and FIG. 13, it may be understood that the chassis 110 is provided with a positioning rib 111 arranged at the bottom of the chassis 110 and protruding outward. A plurality of positioning ribs 111 may be provided, and are positioned and engaged with a periphery of the support plate 200, to facilitate determining of a mounting position of the support plate 200 and establish a stable connection between the support plate 200 and the chassis 110.

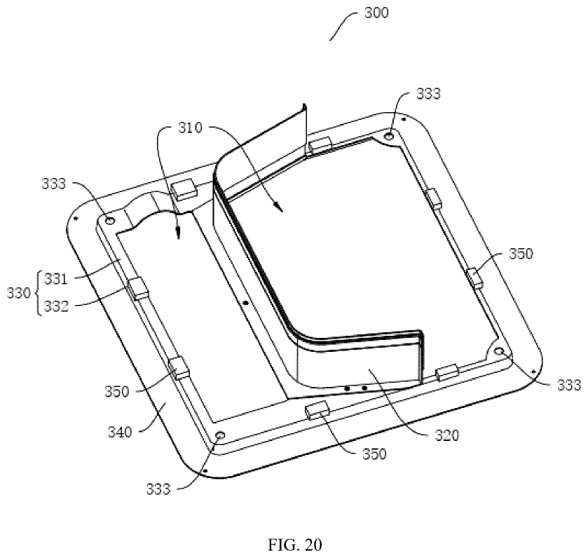

Referring to FIG. 12, FIG. 19, and FIG. 20, it may be understood that, in order to enable an air inlet and an air outlet of the air conditioner body 100 to be in communication with internal environment of the recreational vehicle, the support plate 200 is provided with a first communication hole 210, and the top plate 300 is provided with a second communication hole 310. When the roof-mounted air conditioner is mounted to the roof 2000, the second communication hole 310 is in communication with the first communication hole 210 through a mounting opening 2100. To avoid airflow communication in the air inlet and the air outlet of the air conditioner body 100, the top plate 300 is provided with a partition plate 320 configured to divide the mounting opening 2100 into an air inlet passage and an air outlet passage.

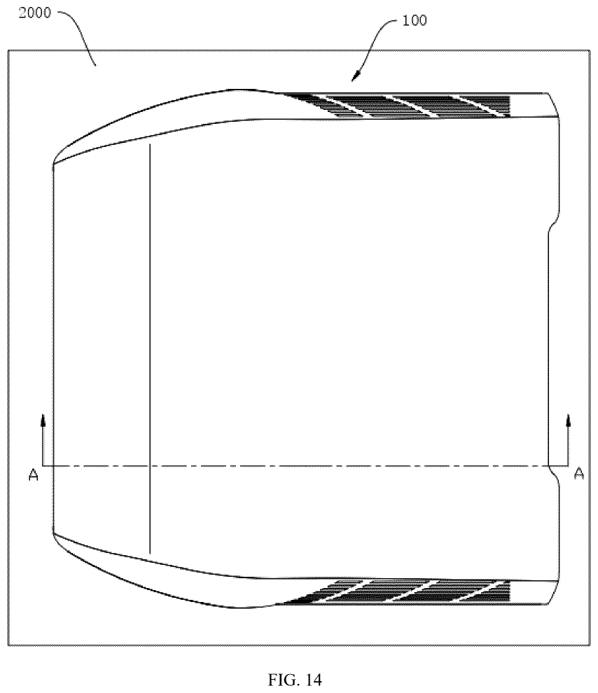

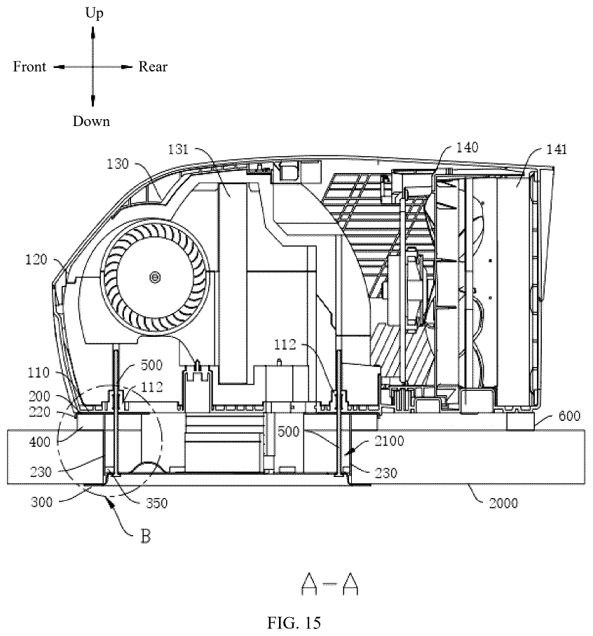

Referring to FIG. 12, FIG. 14, and FIG. 15, it may be understood that the support plate 200 is provided with an inner skirt 230 located at one end of the support plate 200 facing downward, that is, the end facing the mounting opening 2100. The inner skirt 230 may be arranged along a periphery of the first communication hole 210, thereby maximizing a cross-sectional area of the first communication hole 210. The inner skirt 230 may be formed by stamping the support plate 200, such that the inner skirt 230 is formed around an edge of the first communication hole 210. The inner skirt 230 may be fixed to the support plate 200 through welding. It should be noted that, when the roof-mounted air conditioner is mounted to the roof 2000, the inner skirt 230 is in positioning fit with an inner wall of the mounting opening 2100, for example, the inner skirt 230 abuts against the inner wall of the mounting opening 2100, such that the mounting opening 2100 may limit displacement of the support plate 200 in a horizontal direction. In an embodiment of the present disclosure, a cross section of the mounting opening 2100 is rectangular. In this case, the inner skirt 230 includes four skirt units respectively correspond to four inner wall surfaces of the mounting opening 2100 in front, rear, left, and right directions, thereby realizing more stable alignment of the air conditioner body 100 with the mounting opening 2100.

It may be understood that the top plate 300 and the chassis 110 may be fixed by a plurality of bolts 500. The number of bolts 500 may be selected based on a size of the air conditioner body 100 and a size of the mounting opening 2100, which may be, for example, four, six, or more, and is not specifically limited herein. The plurality of bolts 500 are arranged close to the inner wall of the mounting opening 2100, and are arranged at an interval along a circumferential direction of the mounting opening 2100, thereby reducing an impact of the bolts 500 on the air inlet and the air outlet of the roof-mounted air conditioner.

According to the roof-mounted air conditioner in this embodiment of the present disclosure, the support plate 200 mounted at a bottom of the air conditioner body 100 and the top plate 300 mounted to the inner side of the roof 2000 and connected to the air conditioner body 100 by the bolts 500 are provided, the end of the support plate 200 facing the mounting opening 2100 is provided with the inner skirt 230, and the inner skirt 230 is configured to be in positioning fit with the inner wall of the mounting opening 2100 on the roof 2000. Therefore, operator can quickly and accurately align the air conditioner body 100 with the mounting opening 2100, such that the operator does not need to move back and forth between the roof 2000 and an interior of the vehicle many times for adjustment, thereby improving mounting efficiency and accuracy, and improving safety of the operator. Moreover, the design of the inner skirt 230 may further effectively prevent the air conditioner body 100 from shaking or shifting when the operator mounts the top plate 300, such that the operator may fasten the bolts 500 more efficiently and conveniently, and the air conditioner body 100 may be prevented from slipping and damaged, thereby improving mounting safety.

Further, as compared to a mounting arrangement of the conventional roof-mounted air conditioner, the roof-mounted air conditioner in this embodiment of the present disclosure involves fewer parts and operation steps for installation, which is conducive to improving mounting efficiency.

Referring to FIG. 1, FIG. 14, and FIG. 15, it may be understood that the roof-mounted air conditioner further includes a sealing ring 400 arranged between the support plate 200 and the roof 2000 when the roof-mounted air conditioner is mounted to the roof 2000. The sealing ring 400 is arranged between the support plate 200 and the roof 2000 to provide effective sealing, such that the air inlet and the air outlet of the air conditioner body 100 are in sealed communication with the internal environment of the recreational vehicle through the mounting opening 2100. The sealing ring 400 in this embodiment of the present disclosure is made of an elastic material having compressibility, such as sponge, expandable polyethylene, and EVA (also referred to as ethylene-vinyl acetate copolymer). Therefore, the sealing ring 400 may further provide better cushioning effect on vibrations between the air conditioner body 100 and the roof 2000, effectively reduce transmission of vibration generated during bumpy travel of the recreational vehicle to the air conditioner body 100, and reduce shaking of the air conditioner body 100, thereby improving stability of the roof-mounted air conditioner mounted to the recreational vehicle.

Referring to FIG. 13 and FIG. 19, it may be understood that the support plate 200 is further provided with an outer skirt 220 located at the end of the support plate 200 facing downward, that is, the end facing the mounting opening 2100, and the outer skirt 220 is arranged along an outer periphery of the support plate 200. The outer skirt 220 may be integrally molded with the support plate 200, that is, formed by folding downward the outer periphery of the support plate 200. In another embodiment, the outer skirt 220 is fixedly connected to the support plate 200 through welding. The support plate 200 is configured to be in positioning fit with an outer wall of the sealing ring 400 through the outer skirt 220, thereby limiting a position of the sealing ring 400 and realizing more stable mounting of the sealing ring 400. In addition, arrangement of the outer skirt 220 may also enhance structural strength of the support plate 200, thereby improving mounting stability of the roof-mounted air conditioner.

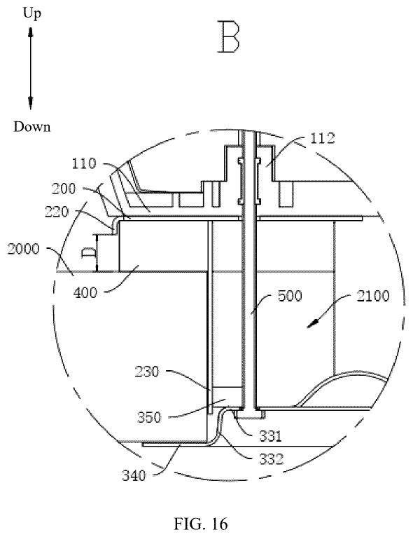

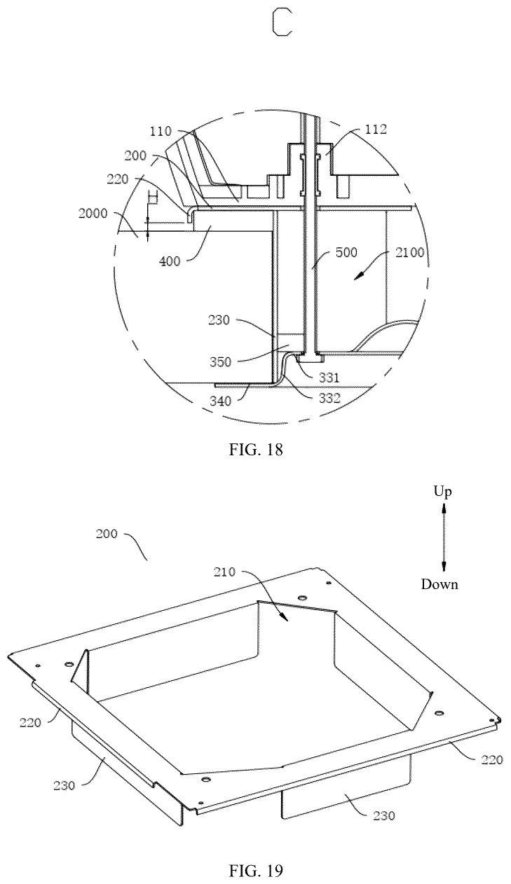

Referring to FIG. 16 and FIG. 18, it may be understood that, when the bolt 500 is in an unfastened state, that is, when the bolt 500 is not fastened to the top plate 300, a clearance between the outer skirt 220 and an upper end face of the mounting opening 2100 is defined as D. When the bolt 500 is in a fastened state, that is, after the roof-mounted air conditioner is mounted to the roof 2000, a clearance between the outer skirt 220 and the upper end face of the mounting opening 2100 is defined as H, which satisfies: 0<H≤0.5 D. It should be noted that, when 0<H≤0.5 D is satisfied, the sealing ring 400 may be compressed to a certain extent after the bolt 500 is fastened, to form a sealed fit with the roof 2000, and the cushioning and damping effects of the sealing ring 400 are ensured at the same time.

Referring to FIG. 1, FIG. 13, and FIG. 15, it may be understood that the roof-mounted air conditioner includes a damping pad 600 that may provide a further cushioning effect. When the roof-mounted air conditioner is mounted to the roof 2000, the damping pad 600 is arranged between the air conditioner body 100 and the roof 2000, and the damping pad 600 is spaced apart from the sealing ring 400 in a front-rear direction of the air conditioner body 100. It may be understood that the damping pad 600 is arranged at a rear portion of the chassis 110 and the sealing ring 400 is arranged at a front portion of the chassis 110, such that the air conditioner body 100 receive more evenly distributed forces, transmission of vibration generated during bumpy travel of the recreational vehicle to the air conditioner body 100 is further reduced, and shaking of the air conditioner body 100 is reduced, thereby improving stability of the roof-mounted air conditioner mounted to the recreational vehicle.

Referring to FIG. 15 and FIG. 16, it may be understood that, in order to facilitate mounting of the top plate 300 by the operator, the top plate 300 is designed to be prefixed to the support plate 200 by, for example a movable fastener, a clamp, or a magnet, in this embodiment of the present disclosure. Therefore, after the air conditioner body 100 is positioned through the support plate 200, the operator in the recreational vehicle may finish the work of prefixing the top plate 300 to the support plate 200. To be specific, the top plate 300 may be secured by directly fastening the bolts 500 with two hands. There is no need for a person to hold the top plate 300 with one hand while fasten the bolt 500 with the other hand, nor is there a need for one person to hold the top plate 300 while another person is fastening the bolt 500, thereby improving mounting efficiency and reducing mounting costs.

Referring to FIG. 15 and FIG. 20, in an embodiment, a mechanism for realizing the pre-fixation may be an attachment member 350. The attachment member 350 may be arranged on the top plate 300, the inner skirt 230, or both the top plate 300 and the inner skirt 230. The top plate 300 and the inner skirt 230 are attached and connected by the attachment member 350 to realize the pre-fixation. For example, the attachment member 350 may be a magnet, an adhesive, or any other material that can realize attachment of the top plate 300 and the inner skirt 230.

Referring to FIG. 19 and FIG. 20, it may be understood that, in order to facilitate production and manufacturing, the attachment member 350 in this embodiment of the present disclosure is a magnet. The attachment member 350 is arranged on the top plate 300, the inner skirt 230 is made of a metal material, and the attachment member 350 is easily attached to the inner skirt 230, thereby realizing the pre-fixation of the top plate 300. This requires lower production costs, and has a more stable structure. A plurality of attachment members 350 may be provided. The plurality of attachment members 350 are arranged at an interval along a circumferential direction of the top plate 300 and are each fixed to the top plate 300, such that the pre-fixation of the top plate 300 is more stable, and a risk of falling off of the top plate 300 is effectively prevented.

It may be understood that, in another embodiment, the top plate 300 is provided with a first fastener, and the support plate 200 is provided with a second fastener. It may be understood that the first fastener may be one of a movable buckle and a ring that match with each other, and correspondingly, the second fastener is the other of one the movable buckle and the ring. After the movable buckle is connected to the ring, the top plate 300 and the support plate 200 can be prefixed, such that the operator may fasten the top plate 300 by directly fastening the bolt 500 with two hands, thereby improving mounting efficiency.

It may be understood that, in another embodiment, the top plate 300 is provided with a first adhesive member configured to be adhered to the inner skirt 230 when the roof-mounted air conditioner is mounted to the roof 2000. It may be understood that the first adhesive member may be made of a material such as double-sided tape, the first adhesive member is arranged at a proper position of the top plate 300, and when the operator mounts the top plate 300, the top plate 300 may be prefixed to the inner skirt 230 through the first adhesive member, such that the top plate 300 is prefixed to the support plate 200, and the operator may fasten the top plate 300 by directly fastening the bolt 500 with two hands, thereby improving mounting efficiency.

It may be understood that, in another embodiment, the first adhesive member may alternatively be configured to be adhered to the roof 2000. It may be understood that the first adhesive member is arranged at a proper position of the top plate 300, and when the operator mounts the top plate 300, the top plate 300 may be prefixed to the inner side of the roof 2000 or the inner wall of the mounting opening 2100 through the first adhesive member, such that the top plate 300 is prefixed to the support plate 200, and the operator may fasten the top plate 300 by directly fastening the bolt 500 with two hands, thereby improving mounting efficiency.

It may be understood that, in another embodiment, the inner skirt 230 is provided with a second adhesive member configured to adhere to the top plate 300. It may be understood that the second adhesive member is arranged at a proper position of the inner skirt 230, and when the operator mounts the top plate 300, the top plate 300 is prefixed to the support plate 200 through an adhesive effect of the second adhesive member to the top plate 300, such that the operator may fasten the top plate 300 by directly fastening the bolt 500 with two hands, thereby improving mounting efficiency.

Referring to FIG. 15, FIG. 16, and FIG. 20, it may be understood that the top plate 300 includes a positioning boss 330 and a mounting flange 340. The mounting flange 340 is arranged around a periphery of the positioning boss 330, and the top plate 300 may be produced by integral stamping, to enhance strength of the positioning boss 330 and the mounting flange 340. The positioning boss 330 protrudes upward and is configured to be in positioning fit with the inner skirt 230. It may be understood that the positioning boss 330 includes an end plate 331 located at one end of the positioning boss 330 facing the support plate 200 and a side plate 332 arranged around the end plate 331 and connected to the mounting flange 340. The positioning boss 330 may be in positioning fit with the inner skirt 230 through the side plate 332 or the end plate 331. When the side plate 332 is used to abut against the inner skirt 230, the inner skirt 230 may limit displacement of the top plate 300 in a horizontal direction of the roof 2000, while the mounting flange 340 is configured to abut against the inner side of the roof 2000 to limit displacement of the top plate 300 in a thickness direction of the roof 2000, thereby realizing accurate alignment of the top plate 300. When the end plate 331 is used to abut against the inner skirt 230, the inner skirt 230 may limit displacement of the top plate 300 in a thickness direction of the roof 2000, while the mounting flange 340 is configured to abut against the inner side of the roof 2000 to also limit the displacement of the top plate 300 in the thickness direction of the roof 2000, and the side plate 332 may be configured to abut against the inner wall of the mounting opening 2100 to limit displacement of the top plate 300 in a horizontal direction of the roof 2000. This embodiment of the present disclosure can effectively prevent the top plate 300 from shaking within the mounting opening 2100, and prevent the air conditioner body 100 from shaking accordingly, thereby improving mounting accuracy of the top plate 300, and facilitating the operator to fasten the bolts 500 between the top plate 300 and the chassis 110.

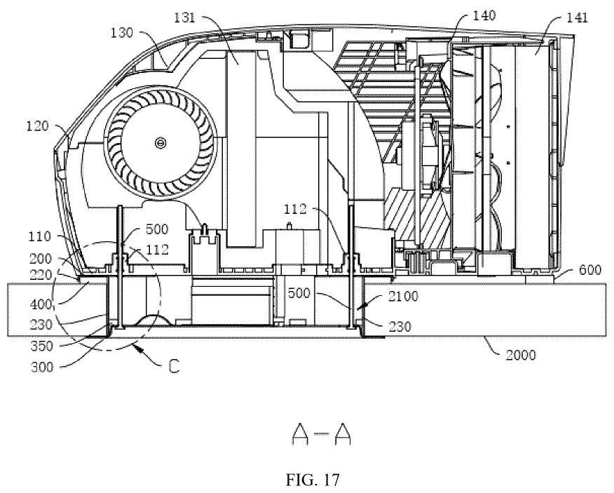

Referring to FIG. 17 and FIG. 18, in an embodiment of the present disclosure, the side plate 332 of the positioning boss 330 is in positioning fit with the inner skirt 230, and one end of the inner skirt 230 facing the top plate 300 abuts against the mounting flange 340. Therefore, when the operator mounts the top plate 300 and fastens the bolt 500, if the operator cannot further apply a force to fasten the bolt 500 since the inner skirt 230 is abutting against the mounting flange 340, it indicates that the bolt 500 has been fastened in place, and the fastening force meets a design standard, to avoid excessive prestressing damage to the chassis 110 due to an excessive fastening force. In this way, when the top plate 300 is fastened and mounted, whether a fastening force is appropriate may be determined without using a torque wrench, thereby improving mounting convenience and mounting reliability of the roof-mounted air conditioner.

Referring to FIG. 20, it may be understood that a magnet may be arranged on an outer periphery of the positioning boss 330, such that the top plate 300 may be prefixed while the top plate 300 is aligned with the inner skirt 230, thereby further improving efficiency of mounting the roof-mounted air conditioner to the recreational vehicle.

Referring to FIG. 20, it may be understood that the end of the positioning boss 330 facing the support plate 200 is provided with the end plate 331, the second communication hole 310 is formed in the end plate 331, and the end plate 331 is provided with a fixation hole 333 for the bolt 500 to be inserted into and fixed to the end plate 331. It may be understood that the fixation holes 333 are distributed around the second communication hole 310, so as to prevent the bolts 500 from affecting the air inlet passage and the air outlet passage after being secured in the fixation hole 333.

In this embodiment of the present disclosure, a cross section of the mounting opening 2100 is rectangular, and a shape of the positioning boss 330 matches with the mounting opening 2100 in shape and is also rectangular. It should be noted that four fixation holes 333 are provided and are respectively located at four corners of the end plate 331, that is, on a side close to the inner wall of the mounting opening 2100. Correspondingly, four bolts 500 are provided, which are respectively secured in the four fixation holes 333, and are fixedly connected to the chassis 110, thereby realizing a stable connection between the top plate 300 and the chassis 110, and further realizing a stable connection between the roof-mounted air conditioner and the roof 2000. It should be noted that the mounting flange 340 is flush against a lower end of the mounting opening 2100. Because the positioning boss 330 and the mounting flange 340 are integrally stamped, the mounting flange 340 transmits a fastening force against the positioning boss 330 when the bolt 500 is fastened upward, such that the mounting flange 340 may be upward secured to the roof 2000 and fastening forces of the four bolts 500 may be evenly distributed. The mounting flange 340 is in a surface contact with the roof 2000 when they clamp, thereby realizing a more stable and reliable installation.

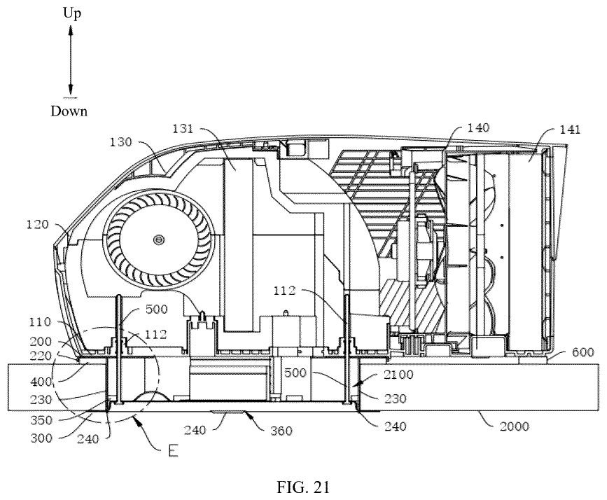

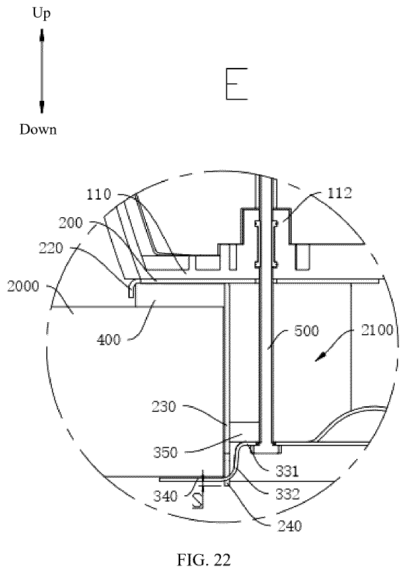

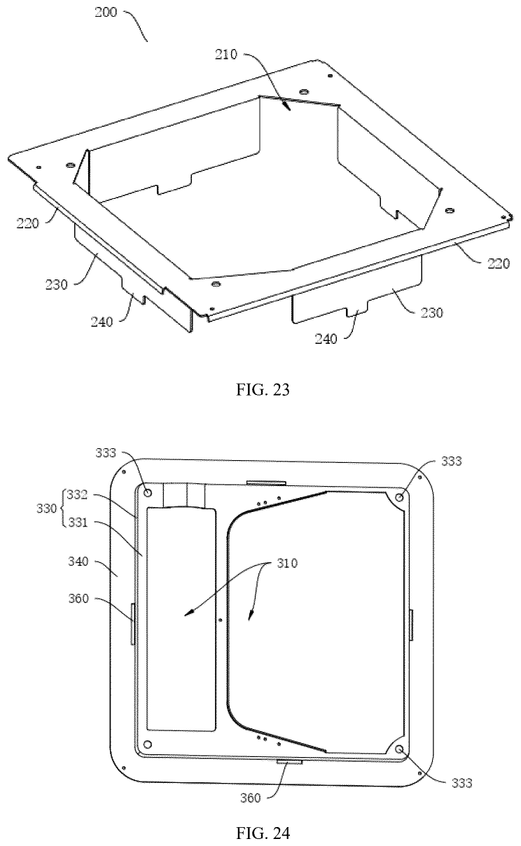

FIG. 21, FIG. 22, FIG. 23, and FIG. 24 show a roof-mounted air conditioner according to another embodiment of the present disclosure. The roof-mounted air conditioner has a structure similar to that of the above embodiments, and an inner skirt 230 is configured to be in positioning fit with a side plate 332 of a positioning boss 330 to limit displacement of a top plate 300 in a horizontal direction of a roof 2000. In addition, the inner skirt 230 in this embodiment of the present disclosure is provided with an indication protrusion 240 arranged at an end of the inner skirt 230 away from the support plate 200, and the indication protrusion 240 extending or protruding toward the top plate 300. Correspondingly, a mounting flange 340 is provided with a hole 360 for the indication protrusion 240 to pass through. It may be understood that, when operator mounts the top plate 300 and fastens a bolt 500, the indication protrusion 240 passes through a lower surface of the mounting flange 340, when it becomes observable by the operator, indicating that the bolt 500 has been mounted in place. That is, force for fastening meets a design standard, and there is no need to continue to screw the bolt 500, thereby ensuring that the fastening force can meet a design requirement. The indication protrusion 240 may show a visible feed back to the operator whether a fastening force of the bolt 500 is appropriate, and such an effective indicative feedback will help avoiding improper mounting of the top plate 300 due to an insufficient fastening force or excessive prestressing damage to a chassis 110 due to an excessive fastening force. In this way, when the top plate 300 is fastened and mounted, whether a fastening force is appropriate may be determined without using a torque wrench, thereby improving mounting convenience and mounting reliability of the roof-mounted air conditioner.

Referring to FIG. 22, it may be understood that the indication protrusion 240 protrudes beyond the hole 360 by a height defined as S, and the height S is greater than or equal to 0 mm and less than or equal to 2 mm. It should be noted that the height S is a dimension of the indication protrusion 240 exposed through the hole 360 along an up-down direction of an air conditioner body 100, and when the height S satisfies the foregoing parameter range, a fastening force meet a design requirement, thereby avoiding a problem caused by an excessive fastening force. When the height S is greater than the foregoing parameter range, even if the operator ignores that the indication protrusion 240 has protruded through the lower surface of the mounting flange 340 and continues to fasten the bolt 500, after the operator completes positioning and mounting of the air conditioner body 100, he will find that the indoor air outlet component 700 cannot be mounted because the indication protrusion 240 protrudes too much. In this case, to prevent the indication protrusion 240 from pushing against the indoor air outlet component 700, the operator can only unfasten the bolt 500 to allow the indication protrusion 240 to be partially retracted upward, until the protruding height S of the indication protrusion 240 meets the design requirement, and then the indoor air outlet component 700 can be mounted. Therefore, a fastening force of the top plate 300 may be controlled by the design of the indication protrusion 240, to meet the design requirement, thereby ensuring that overall fixing strength of the roof-mounted air conditioner is also within an appropriate range.

An embodiment of the present disclosure provides a vehicle having the roof-mounted air conditioner in the foregoing embodiments. The vehicle may be a recreational vehicle or another type of vehicle. Because the vehicle adopts all the technical solutions of the roof-mounted air conditioner in the foregoing embodiments, the vehicle has at least all the advantages brought by the technical schemes of the foregoing embodiments, so details are not described herein again.

Although embodiments of the present disclosure have been described in detail above with reference to the accompanying drawings, the present disclosure is not limited to the foregoing embodiments, and various changes can be made within the knowledge of those having ordinary skills in the art without departing from the scope of the present disclosure.

1.-26. (canceled)

27. A roof-mounted air conditioner comprising:
an air conditioner body;
a sealing ring configured to be fixed to an outer side of a roof of a vehicle;
a support plate mounted at a bottom of the air conditioner body and provided with a first communication hole, one end of the support plate facing downward abutting against the sealing ring, and an outer skirt being arranged along an outer periphery of the support plate and being in positioning fit with an outer wall of the sealing ring; and
a top plate located below the support plate and fixedly connected to the air conditioner body by bolts, the top plate being provided with a second communication hole;
wherein when the air conditioner is mounted to an mounting opening on the roof, the sealing ring is arranged around a periphery of the mounting opening, and the second communication hole is in communication with the first communication hole through the mounting opening.

28. The roof-mounted air conditioner of claim 27, wherein the top plate includes a positioning boss and a mounting flange, the mounting flange is arranged around a periphery of the positioning boss, and the positioning boss protrudes upward and is in positioning fit with an inner wall of the mounting opening.

29. The roof-mounted air conditioner of claim 28, wherein one end of the positioning boss facing the support plate is provided with an end plate, and the end plate is provided with fixation holes for securing the bolts.

30. The roof-mounted air conditioner of claim 29, wherein the positioning boss is rectangular, the fixation holes include four fixation holes provided and respectively located at four corners of the end plate, and the bolts include four bolts provided and respectively secured in the corresponding ones of the four fixation holes.

31. The roof-mounted air conditioner of claim 27, wherein the outer skirt is formed by folding downward the outer periphery of the support plate.

32. The roof-mounted air conditioner of claim 27, wherein the end of the support plate facing downward is further provided with an inner skirt, and at least one of the top plate or the inner skirt is provided with an attachment member configured to attach and connect the top plate and the support plate.

33. The roof-mounted air conditioner of claim 32, wherein the attachment member includes a magnet, the magnet is arranged on the top plate, and the inner skirt is made of a metal material.

34. The roof-mounted air conditioner of claim 27, wherein the top plate is provided with a first fastener, the support plate is provided with a second fastener, and the second fastener is buckled with the first fastener to prefix the top plate and the support plate.

35. The roof-mounted air conditioner of claim 27, wherein the top plate is provided with an adhesive member configured to be adhered to the roof when the roof-mounted air conditioner is mounted to the roof.

36. The roof-mounted air conditioner of claim 27, wherein the end of the support plate facing downward is further provided with an inner skirt, and at least one of the top plate or the inner skirt is provided with an adhesive member configured to adhere to the top plate and the inner skirt when the roof-mounted air conditioner is mounted to the roof.

37. The roof-mounted air conditioner of claim 27, wherein the air conditioner body includes a chassis, the chassis is provided with a positioning rib, and the support plate is in positioning fit with the positioning rib.

38. The roof-mounted air conditioner of claim 27, further comprising:
a damping pad spaced apart from the sealing ring, and configured to be arranged between the air conditioner body and the roof when the air conditioner is mounted to the roof.

39. A roof-mounted air conditioner comprising:
an air conditioner body;
a support plate mounted at a bottom of the air conditioner body and provided with a first communication hole, one end of the support plate facing downward being provided with an inner skirt; and
a top plate located below the support plate and fixedly connected to the air conditioner body by bolts, the top plate being provided with a second communication hole;
wherein when the roof-mounted air conditioner is mounted to an mounting opening on the roof, the inner skirt is in positioning fit with an inner wall of the mounting opening, and the second communication hole is in communication with the first communication hole through the mounting opening.

40. The roof-mounted air conditioner of claim 39, wherein at least one of the top plate or the inner skirt is provided with an attachment member configured to attach and connect the top plate and the support plate.

41. The roof-mounted air conditioner of claim 40, wherein the attachment member includes a magnet, the magnet is arranged on the top plate, and the inner skirt is made of a metal material.

42. The roof-mounted air conditioner of claim 39, wherein the top plate is provided with a first fastener, the support plate is provided with a second fastener, and the second fastener is buckled with the first fastener to prefix the top plate and the support plate.

43. The roof-mounted air conditioner of claim 39, wherein the top plate includes a positioning boss and a mounting flange, the mounting flange is arranged around a periphery of the positioning boss, and the positioning boss protrudes upward and is in positioning fit with the inner skirt.

44. The roof-mounted air conditioner of claim 43, wherein the inner skirt is in positioning fit with a side plate of the positioning boss, and one end of the inner skirt facing the top plate abuts against the mounting flange.

45. The roof-mounted air conditioner of claim 43, wherein the inner skirt is in positioning fit with a side plate of the positioning boss, one end of the inner skirt away from the support plate is provided with an indication protrusion, and the mounting flange is provided with a hole for the indication protrusion to pass through.

46. The roof-mounted air conditioner of claim 45, wherein the indication protrusion protrudes beyond the hole by a height S satisfying: 0 mm≤S≤2 mm.
